(19) United States
(12) Patent Application Publication
(10) Pub. No.: US 2023/0320243 A1
(43) Pub. Date: Oct. 12, 2023

(54) SOIL CULTIVATOR

(71) Applicant: Engelbert Rath, JR., Pfatter (DE)

(72) Inventor: Engelbert Rath, JR., Pfatter (DE)

(21) Appl. No.: 18/295,162

(22) Filed: Apr. 3, 2023

(30) Foreign Application Priority Data
Apr. 6, 2022 (DE) 102022108246.6

(51) Int. Cl. A01B 39/18; A01B 63/108; A01B 63/02; A01B 23/04

(52) U.S. Cl. CPC A01B 39/18; A01B 63/108; A01B 63/023; A01B 23/043

(57) ABSTRACT

A soil cultivator for mechanical weed control between rows of cultivated plants includes a frame attachable to a tractor for movement along a traveling direction, and at least one soil processing unit attached to the frame. The at least one soil control unit includes a deformable sub-frame made of an elastic material. The soil cultivator further comprises a first adjusting means connected to the deformable sub-frame via at least one first connecting element, and a second adjusting means connected to the deformable sub-frame via at least one second connecting element. At least one adjusting unit is provided for carrying out a movement of the first and the second adjusting means, such that the deformable sub-frame is elastically deformable by the movement of the first and the second adjusting means such that the extent of the deformable sub-frame changes transversely to the traveling direction.

### CROSS-REFERENCE TO RELATED APPLICATIONS

This application claims the benefit of German Patent Application No. DE 10 2022 108 246.6, filed Apr. 6, 2022, the disclosure of which is hereby incorporated herein in its entirety by reference.

### BACKGROUND OF THE INVENTION

### Field of the Invention

The present invention relates to a soil cultivator for mechanical weed control.

### Background & Description of Related Art

Soil cultivation devices for mechanical weed control between rows of cultivated plants are known in manifold variants. A central component of such soil cultivation devices are hoeing devices and, in particular, hoe shares or cultivator sweeps which serve to sever or loosen the roots of weeds and similar undesirable growth in the soil. To do this, the cultivator sweep is pulled through the soil at a shallow depth, usually using a depth guide wheel that allows the share to follow the contours of the soil.

It can happen that so many roots remain embedded in larger chunks of soil that the weeds continue to grow, especially if there is no drying out of the chunks of soil in wet weather. For this reason, cultivator sweeps are often combined with harrow tines, which serve both to break up the clods and chunks of soil dislodged by the cultivator sweeps and to pull the weeds to the soil surface. In both cases, the roots of the weeds are exposed, dry out and can no longer grow. Such soil cultivation devices are known, for example, from EP 0 426 960 B1, DE 35 21 785 C2 or U.S. Pat. No. 5,168,936 A.

The aim of any weed control and also of any mechanical weed control is to remove the weeds between the rows of cultivated plants as completely as possible. Of particular importance in this regard is to also remove weeds that grow relatively close to the crop plants. However, weed control must not cause relevant damage to the crop plants. This raises the problem that the above-described cultivator sweeps and harrow tines should be guided in such a way that weeds growing close to the crops are also controlled, but with as little damage to the crops themselves as possible. Therefore, when soil cultivation devices are used on agricultural land, especially on fields, it would be advantageous in mechanical weed control if the line along which cultivator sweeps and harrow tines are guided could be adapted to the real conditions of the particular cultivated area.

In this connection, FR 2 359 570 A1 discloses a soil cultivator having a base frame and a plurality of subframes arranged in the base frame and formed in the manner of a parallelogram. At least two cultivator sweeps are attached to each of the subframes, the distance between which can be adjusted transversely to the traveling direction, in each case by means of an actuating lever which compresses or stretches the corresponding subframe.

From DE 817 828 B a device for holding soil cultivation implements such as goose feet, cultivator tines, etc. is known, wherein the individual tool holders of the soil cultivators are adjustably mounted. Furthermore, a single adjusting means is provided, by the actuation of which the distances between the tool holders can be changed simultaneously and uniformly. To change the distance between the tool holders, a “Nuremberg shear” is used, the links of which can be moved towards or away from each other by means of a spindle with right-hand and left-hand threads.

However, the use of this soil cultivators proves to be impractical. The main disadvantage of the solutions described is that the tillage operation must be interrupted to adjust the distance between the cultivator sweeps. This means that every time the distance between the cultivator sweeps needs to be adjusted, the tractor must be stopped, and the distance adjusted manually. This results in an extremely time-consuming effort that cannot be carried out in an economically justifiable manner in practice.

There is, therefore, a need for soil cultivators for mechanical weeding between rows of cultivated plants, in which the line along which the cultivator sweeps and harrow tines are guided could be adapted to the real conditions of the particular cultivation area in a simple manner and without a great expenditure of time.

### SUMMARY OF THE INVENTION

The problem underlying the present invention is to provide a soil cultivator for mechanical weed control between rows of cultivated plants, in which the line along which cultivator sweeps and harrow tines are guided can be changed in a simple manner without a great expenditure of time.

According to the invention, this problem is solved by the soil cultivator according to claim 1. Further advantageous details, aspects and embodiments of the present invention will be apparent from the dependent claims, the description, the examples and the drawings.

The present invention provides a soil cultivator for mechanical weed control between rows of cultivated plants. The soil cultivator has a frame attachable to a tractor for movement along a traveling direction. The soil cultivator further comprises at least one soil processing unit attached to the frame, the at least one soil processing unit comprising a frame-like element or deformable sub-frame made of an elastic material. The soil cultivator further comprises a first movably configured adjusting means, the first adjusting means being connected to the deformable sub-frame via at least a first connecting element, and a second movably configured adjusting means, the second adjusting means being connected to the deformable sub-frame via at least a second connecting element. In addition, at least one adjusting unit is provided for carrying out a movement of the first and the second adjusting means, the deformable sub-frame being elastically deformable by the movement of the first and the second adjusting means in such a way that the extent of the deformable sub-frame changes transversely to the traveling direction F.

The essence of the present invention lies in the idea of combining a deformable sub-frame consisting of an elastic material, which is variable in shape due to the elastic properties of the elastic material, with a device which causes the shape of the deformable sub-frame to be adjusted by a movement of adjusting means. As described in more detail below, this creates the possibility of moving cultivating tools arranged on or supported by the deformable sub-frame, such as cultivator sweeps or harrow tines, in the broadest sense, but in particular of changing the distance between several such cultivating tools and thus adapting them to the real conditions of a particular field. In particular, this allows the line along which, for example, cultivator sweeps and harrow tines are guided to be changed in a simple manner without requiring a great deal of time.

The functionality of the deformable sub-frame consisting of an elastic material is based on the elastic properties of the material of which the deformable sub-frame consists or consists for the most part. Elasticity is generally understood, and also in the context of the present text, to be the property of a body or material to change its shape when a force is applied and to return to its original shape when the applied force is removed.

When the adjusting means provided in accordance with the invention and connected to the deformable sub-frame are moved, this movement is converted into a change in the shape of the deformable sub-frame. If the adjusting means are subsequently moved back to their original position, the deformable sub-frame also resumes its original shape and position due to its elastic properties. Since, according to the invention, the deformable sub-frame can be elastically deformed by the movement of the first and second adjusting means in such a way that the extent of the deformable sub-frame changes transversely to the traveling direction, a change in the distance between cultivating tools arranged on the deformable sub-frame can be effected in this way, which is designed to be reversible due to the elastic properties of the deformable sub-frame.

The adjusting means, which are each connected to the deformable sub-frame via at least one connecting element, thus ensure that a movement of the adjusting means is converted into a movement of the deformable sub-frame. In this case, the movement of the adjusting means is transmitted via the connecting means to the deformable sub-frame, the elastic properties of which allow the width of the deformable sub-frame to be adjusted transversely to the traveling direction.

In the most general case, the movement of the adjusting means can be affected by a drive means associated with the adjusting means. The drive means may be, for example, a hydraulic cylinder, which is preferably equipped with a displacement measuring system. However, a separate drive means can also be assigned to each adjusting means.

Any type of material with elastic properties can be used as the elastic material of the deformable sub-frame provided according to the invention. As is known, any material basically exhibits elastic properties to a certain extent, but in the context of the present text reference is made to materials whose elastic properties can be used with an effort that is justifiable in practice. The person skilled in the art is of course aware that the elastic properties of a macroscopic body do not depend exclusively on the elastic properties of the material of which this body is made, but also on the dimensions of the body. Thus, if in the context of the present text reference is made to a deformable sub-frame consisting, for example, of spring steel, it will be clear to the person skilled in the art that this deformable sub-frame is used in soil cultivation in the agricultural sector. The skilled person will conclude that the deformable sub-frame is neither meter-thick steel blocks, nor metal foils with a thickness in the micrometer range. Rather, the skilled person will casually choose the dimensioning of the deformable sub-frame in such a way that, on the one hand, the element has the desired elastic properties, but, on the other hand, is designed to be stable enough to withstand the stresses of working agricultural land.

Preferably, the elastic material is an elastomer, a thermoplastic, a rubber, in particular hard rubber, or steel, in particular spring steel. Preferably, the steel is a stainless steel, and in particular, preferably a chromium-nickel stainless steel. Particularly preferred is 1.4310 stainless steel. Hardox® steel also exhibits particularly good properties.

The deformable sub-frame is preferably in one piece or made up of several sub-elements which are immovable relative to one another and firmly connected to one another. A one-piece design of the deformable sub-frame means that the entire element is made of the elastic material. If the deformable sub-frame is constructed from a plurality of sub-elements, these individual sub-elements consist of the elastic material. The individual elastic sub-elements are immovable relative to each other and are fixedly connected to each other. Any type of fixing element, i.e., clamps, screws, rivets, etc., can be used to connect the individual sub-elements. These fixing elements are usually not formed of an elastic material, but of the metallic materials usual for the respective type of fixing element. In this case, strictly speaking, the deformable sub-frame is not made of the elastic material, but is predominantly composed of this material. However, it is clear to the skilled person that the elastic properties of the deformable sub-frame desired and required in the context of the present invention are not influenced by the fixing elements consisting of non-elastic material. It is therefore quite appropriate to speak of the deformable sub-frame being made of an elastic material also in the case of sub-elements fixed to each other by fixing elements.

As explained in more detail below, the deformable sub-frame can have a wide variety of shapes. Basically, possible are an open and a closed shape of the deformable sub-frame. In the case of an open shape, the deformable sub-frame has a C-shaped or U-shaped or somehow otherwise pronounced open shape with two ends. In the case of a closed shape, the deformable sub-frame has a continuous shape. Thus, it has a self-contained shape, for example an oval, a circle, a rectangle, a rhombus or any other distinct closed shape without ends.

According to a particularly preferred embodiment of the present invention, the deformable sub-frame extends in a plane. As explained above, the deformable sub-frame is elastically deformed by the movement of the first and second adjusting means in such a way that the extent of the deformable sub-frame changes transversely to the traveling direction. In this way, a change in the distance between the cultivating tools arranged on the deformable sub-frame can be affected. For the person skilled in the art, it is self-evident that this change in the distance between the cultivating tools should take place in a horizontal direction. After all, the practical application of the invention is to improve weed control between rows of cultivated plants by controlling weeds growing close to the crops. To achieve this, the cultivating tools must be moved as close as possible to the cultivated plants without damaging them. This goal can be achieved by changing the distance between the cultivating tools in a horizontal direction.

However, changing the distance between the cultivating tools by elastic deformation of the deformable sub-frame can most effectively be done by forming the deformable sub-frame substantially in a plane. Particularly preferably, the deformable sub-frame is arranged on the soil processing unit in such a way that the plane of the deformable sub-frame is formed in the horizontal direction. In this case, any movement of the adjusting means can be converted directly proportionally into a change in the distance between the cultivating tools.

Particularly preferably, the deformable sub-frame has at least one loop, the loop extending in the plane of the deformable sub-frame or perpendicular to the plane of the deformable sub-frame. With a loop arranged in the plane of the deformable sub-frame, the elastic deformability of the deformable sub-frame is improved. In the region of a loop arranged perpendicular to the plane of the deformable sub-frame, a cultivating tool can advantageously be attached, in particular a cultivator sweep, which can then resiliently follow any unevenness of the ground.

In order to effect the change in the extent of the deformable sub-frame transverse to the traveling direction provided for in accordance with the invention in a particularly simple manner, a movement of the first and the second adjusting means in opposite directions is particularly preferred. In principle, a movement of the two adjusting means to different extents in the same direction or even a movement of the adjusting means in any direction, which need only have a component in the plane of the deformable sub-frame, can also be converted into a change in the extent of the deformable sub-frame transverse to the traveling direction. However, the least complex in terms of design is the transmission of a movement of the first and second adjusting means oriented in opposite directions to the deformable sub-frame. Particularly preferably, the adjusting unit provided in accordance with the invention can affect a linear movement of the first and second adjusting means oriented transversely to the traveling direction. Very preferably, the movement of the first adjusting means can be affected antiparallel to the movement of the second adjusting means. By means of this embodiment, a particularly strong deformation of the deformable sub-frame transverse to the traveling direction can be affected by a certain extent of movement of the adjusting means.

According to a particularly preferred embodiment of the present invention, at least one movement transmission means is provided, wherein the at least one adjusting unit for carrying out a movement of the first and the second adjusting means is connected to the first adjusting means and the second adjusting means via the at least one movement transmission means. Particular advantages result from the fact that the movements of the first and the second adjusting means are not affected by two different adjusting units, but that only one adjusting unit has to be provided which moves both adjusting means. However, the present application of course also covers embodiments having a plurality of adjusting units and a plurality of movement transmission means.

Particularly preferred are embodiments in which only one movement transmission means is used, which is connected to both the first adjusting means and the second adjusting means. In this case, a movement that can be affected by the adjusting unit is transmitted to both adjusting means simultaneously via the one movement transmission means.

Particularly preferred are embodiments in which a movement transmission means having an elongated shape is used, which is fixed at one point but rotatably connected to the frame. If the adjusting unit is connected to the elongated movement transmission means in the region of one end thereof, a movement caused by the adjusting unit is converted into a rotation of the movement transmission means. In a manner known to the skilled person, the adjusting unit is pivotably mounted in this case and can thus follow the deflection of the movement transmission means due to its rotational movement. In a manner known to the skilled person, at least one elongated hole is provided in the movement transmission means, in which a bulge or a connecting means of the second adjustment means engages. Due to its design as an elongated hole, the movement transmission means can perform a rotary motion without causing the actuator to move in the traveling direction.

A toothed wheel can also be used as a movement transmission means, which engages in a section formed as a toothed rack on the first and second adjusting means. A rotation of the toothed wheel moves the two adjusting means in an antiparallel direction. The rotation of the toothed wheel can be affected by manual pivoting of, for example, a lever-like element which is fixedly connected to the axis of rotation of the gear wheel. Further, a means for fixing the lever-like element and thus the toothed wheel in a certain position may be provided.

According to a further preferred embodiment, the first connecting element is provided with at least one joint and the second connecting element is provided with at least one joint. When the soil cultivator according to the invention is used on the field, up and down movements of the soil processing unit occur, which are caused by unevenness of the soil transmitted by a depth guide wheel described in more detail below. The connecting means, each equipped with at least one joint, can easily follow these movements by means of their joints.

According to a particularly preferred embodiment of the present invention, a pipe arranged transversely to the traveling direction is provided, the pipe having at least a first guide sleeve and a second guide sleeve. The first guide sleeve is provided on its outer side with a first force transmission means and the second guide sleeve is provided on its outer side with a second force transmission means. In this case, the connection of the first, movably configured adjusting means to the deformable sub-frame is realized in that the first, movably configured adjusting means is connected to the first guide sleeve via the first force transmission means and the first guide sleeve is connected to the deformable sub-frame via the first connecting element. The connection of the second, movably configured adjusting means to the deformable sub-frame is formed in that the second, movably configured adjusting means is connected to the second guide sleeve via the second force transmission means and the second guide sleeve is connected to the deformable sub-frame via the second connecting element.

According to this embodiment, the deformable sub-frame, which is variable in shape due to its elastic properties, is combined with a device which causes the shape of the deformable sub-frame to be adjusted by a linear movement of sleeves along a pipe.

By means of the guide sleeves provided on the pipe and their connection to the deformable sub-frame, it is achieved that a movement of the guide sleeves is converted into a deformation of the deformable sub-frame. In this case, the movement of the guide sleeves is transmitted to the deformable sub-frame via connecting means, the elastic properties of the deformable sub-frame allow the width of the deformable sub-frame to be adjusted transversely to the traveling direction. The movement of the guide sleeves is caused by two adjusting means, one of which is connected to each guide sleeve. The movement of the adjusting means is transmitted to the guide sleeves via a respective force transmission means.

The connection of the first, movably configured adjusting means to the deformable sub-frame provided according to the invention is thus realized in this case in that the first, movably configured adjusting means is connected to the first guide sleeve via the first force transmission means and the first guide sleeve is connected to the deformable sub-frame via the first connecting element. The connection of the second, movably configured adjusting means to the deformable sub-frame is realized in that the second, movably configured adjusting means is connected to the second guide sleeve via the second force transmission means and the second guide sleeve is connected to the deformable sub-frame via the second connecting element.

The structural realization of the soil cultivator is particularly simple in the case where the guide sleeves are attached to a pipe arranged transversely to the traveling direction. The same applies to the transmission of the movement of the adjusting means via a respective force transmission means to the guide sleeves. This transmission is particularly easy to implement in that the first adjusting means is a first adjusting means designed to be movable transversely to the traveling direction and the second adjusting means is a second adjusting means designed to be movable transversely to the traveling direction. In this case, the movement of the adjusting means can be converted directly into a movement of the first guide sleeve and the second guide sleeve oriented transversely to the traveling direction via the force transmission means provided in accordance with the invention. If the two guide sleeves move towards each other, the expansion of the deformable sub-frame transverse to the traveling direction is reduced. If the two guide sleeves move away from each other, the extent of the deformable sub-frame transverse to the traveling direction is increased.

Therefore, particularly preferred are embodiments with a first adjusting means designed to be movable transversely to the traveling direction and a second adjusting means designed to be movable transversely to the traveling direction. The adjusting means are preferably pipes arranged transversely to the traveling direction.

The movable adjusting means may also be implemented by a first and a second threaded sleeve cooperating with a first and a second engagement means. The first and second engagement means are attached to a pipe arranged transversely to the traveling direction. The first engagement means is in engagement with the first threaded sleeve having a left-handed inner thread, and the second engagement means is in engagement with the second threaded sleeve having a right-handed inner thread, the first threaded sleeve and the second threaded sleeve each being connected to the deformable sub-frame via at least one connecting element. As a result of a rotation of the pipe about its longitudinal axis, the threaded sleeves are moved relative to one another in such a way that, due to the transmission of the movement via the connecting elements to the deformable sub-frame, the extent of the deformable sub-frame changes transversely with respect to the traveling direction.

Particularly preferred are embodiments in which the first guide sleeve and the second guide sleeve are designed to be movable in opposite directions.

At this point, it should be noted that arrangements of certain parts of the soil cultivator relative to a lane centerline are described several times below. The lane centerline is an imaginary line running down the middle of the lane between two rows of cultivated plants. Therefore, when the soil cultivator is used, the lane centerline is parallel to the traveling direction in which the soil cultivator is moved. Thus, when the arrangement of certain parts of the soil cultivator is defined relative to the lane centerline, it is not a problem for the person skilled in the art to recognize that this refers to the arrangement of these parts on the soil cultivator when it is used in the field.

In the context of the present invention, a “pipe” is understood to mean an elongated, element which may be hollow or a solid body. This may be a circular, oval or even angular element in cross-section. A cylindrical body can thus be used as well as a square pipe.

The guide sleeves arranged on the pipe surround the pipe with a substantially accurate fit. Depending on the design of the pipe, the guide sleeves have a different cross-section. If the pipe is a cylinder, for example, the guide sleeves are designed as hollow cylinders. If the pipe is a profiled pipe with basically any number of edges, the guide sleeves have a corresponding number of edges.

The guide sleeves arranged on the pipe do not have to completely surround the pipe, but can also be formed in a non-closed shape. In the case of a cylindrical pipe or a pipe with an oval cross-section, for example, the guide sleeves can be C-shaped. In the case of a square pipe, the guide sleeves may be formed in a substantially U-shape, with the angles between the web and the leg of the “U” being 90°, so the transition is angular. In addition, short projections overlapping the pipe would have to be provided at the ends of the legs to ensure a secure fit of the guide sleeve on the pipe.

The frame of the soil cultivator preferably has a three-point tower, known per se, with the aid of which the connection of the soil cultivator to a three-point linkage of the tractor can be made.

Particularly preferably, the first and the second force transmission means are a first and a second rod part, the first and the second rod part having different lengths. In this way, a fixed connection between guide sleeves and adjusting means is possible in a structurally particularly simple manner. Due to the different lengths of the first and second rod parts, the adjusting means can be arranged offset to each other in the traveling direction. It is clear to the person skilled in the art that the first and second force transmission means can have a certain flexibility in the vertical direction and may only be designed so as not to be deformable in the horizontal direction. In fact, the connection between the guide sleeves and the adjusting means must be designed to be rigid only in the horizontal direction for force transmission. Due to the soil processing unit being movably arranged on the frame in the vertical direction, a vertical movement of the pipe relative to the adjusting means may occur. This vertical movement can be made possible in various ways. For example, the force transmission means can be equipped with a joint or be designed as a telescopic rod. However, the connecting elements that connect the guide sleeves to the deformable sub-frame can also be designed to be flexible in the vertical direction. In this case, too, joints or telescopic rods can be used.

When the soil cultivator according to the invention is used in the field, high material stresses occur. In particular, the up and down movements of the soil processing unit, which are caused by ground unevenness transmitted by a depth guide wheel described in more detail below, can lead to premature wear of the means attached to the soil processing unit. The use of guide sleeves arranged on a pipe opens up the possibility of making this pipe in hard-chrome plated form. Wear of the guide sleeves is therefore not to be expected. In addition, the possibility is created for the pipe to be designed as a frame pipe or to be firmly connected to a frame pipe.

According to a further, particularly preferred embodiment, the first and the second force transmission means are each a pin-like protrusion on the outside of the first guide sleeve and on the outside of the second guide sleeve, respectively. The first adjusting means and the second adjusting means each have a fork-like pair of protrusions on the outside thereof, the pin-like protrusion of the first guide sleeve being in engagement with the fork-like pair of protrusions of the first adjusting means and the pin-like protrusion of the second guide sleeve being in engagement with the fork-like pair of protrusions of the second adjusting means. In this embodiment, the first adjusting means and the second adjusting means are connected to the deformable sub-frame via a respective guide sleeve, and the guide sleeves are connected to the deformable sub-frame via at least one respective connecting member.

According to a preferred embodiment, the deformable sub-frame has a parallelogram-like shape in plan view. The particular advantage of a deformable sub-frame in a parallelogram-like shape is that the elastic properties of the deformable sub-frame can be used as effectively as possible to change the extent of the deformable sub-frame transversely to the traveling direction.

Particularly preferred are embodiments in which the deformable sub-frame is in the form of a rhombus. A rhombus is known to be a convex quadrilateral whose four sides are of equal length. Rhombuses are special forms of parallelograms. A deformable sub-frame in the form of a rhombus has the advantages mentioned in connection with a parallelogram-like shape. In addition, the rhombus has a high degree of symmetry, allowing an identical change in the shape of the deformable sub-frame on both sides of the lane centerline.

In general, embodiments in which the deformable sub-frame has an axis of symmetry in the traveling direction are particularly preferred. In this case, the deformable sub-frame is symmetrical with respect to the lane centerline. Since the first adjusting means is particularly preferably connected via the first connecting means to a part of the deformable sub-frame arranged on one side of the axis of symmetry, and since the second adjusting means is particularly preferably connected via the second connecting means to the part of the deformable sub-frame arranged on the other side of the axis of symmetry, a symmetrical movement of the two adjusting means also causes a symmetrical deformation of the deformable sub-frame.

Particularly preferably, the adjusting unit is an electric or hydraulic actuator that can be controlled by means of a control unit. In this way, the movement of the adjusting means can be carried out from the tractor even during soil cultivation. The width of the deformable sub-frame can thus be easily and quickly adjusted to the prevailing conditions on the field, if required, without having to interrupt the soil cultivation process. The adjusting unit can also be equipped with a displacement measuring system known from the prior art.

An electric actuator can expediently comprise a geared motor arranged on the frame, which is coupled, for example via a belt or chain drive, to at least one adjusting wheel for rotating at least one drive shaft connected to an adjusting means. A hydraulic drive which is particularly advantageous with respect to the energy supply and is therefore most suitable for driving even large soil cultivation devices with a plurality of soil processing units may comprise a hydraulic cylinder arranged on the frame, which is coupled via a traction means arrangement to at least one adjusting wheel for rotating at least one drive shaft connected to an adjusting means.

However, the adjusting unit may also be a manually operated element. In this case, the movement of the adjusting means cannot be performed from the tractor during tillage. Rather, in order to adjust the width of the deformable sub-frames to the respective conditions on the field, the soil cultivation process must be interrupted in order to move the adjusting unit manually. The disadvantage of interrupting the soil cultivation process is offset by a significant reduction in the manufacturing costs of the soil processing unit while at the same time improving its robustness and resistance to stresses in use.

A linear movement of the first and second adjusting means oriented transversely to the traveling direction is also affected by a manually operable element as an adjusting unit, the movement of the first adjusting means being oriented antiparallel to the movement of the second adjusting means. In this way, the movement of the adjusting means is converted directly proportionally into a corresponding change in the extent of deformable sub-frames transverse to the traveling direction.

According to a particularly preferred embodiment of the present invention, the first guide sleeve is connected to the deformable sub-frame by two connecting elements. By using two connecting elements, which are preferably each attached to one of the two end portions of the guide sleeve, to connect the guide sleeve and the deformable sub-frame, improved stability of the structure is achieved. Particularly preferably, the second guide sleeve is accordingly connected to the deformable sub-frame by two connecting elements.

According to a further, particularly preferred embodiment of the present invention, a plurality of soil processing units with a plurality of deformable sub-frames is arranged on the frame. By a movement of the first adjusting means and the second adjusting means, the plurality of deformable sub-frames is deformed in such a way that the extent of the deformable sub-frames changes in an identical manner transversely to the traveling direction. This embodiment takes into account the fact that modern agricultural cultivators have a width of several meters, and thus a plurality of lanes between rows of cultivated plants can be worked simultaneously in one operation. With the described embodiment, all deformable sub-frames are deformed synchronously and the cultivating tools attached to them are moved synchronously. A change in conditions or crop type of the cultivated area perceived by the farmer on the tractor can thus be reacted to immediately with a corresponding adjustment of the width of all deformable sub-frames.

According to another particularly preferred embodiment of the present invention, in the case where a plurality of processing units comprising a plurality of deformable sub-frames are arranged on the frame, a pipe arranged transversely to the traveling direction is provided with a number of first and second engagement means corresponding to the number of soil processing units. Each of the first engaging means is engaged with a respective first adjusting means having a left-handed inner thread and formed in the form of a first threaded sleeve, and each of the second engaging means is engaged with a respective second adjusting means having a right-handed inner thread and formed in the form of a second threaded sleeve. By means of the engagement means provided on the pipe and their combination with threaded sleeves provided with inner threads having different threads, it is achieved that rotation of the pipe in one direction causes an increase in the distance between the two threaded sleeves and rotation of the pipe in the other direction causes a decrease in the distance between the two threaded sleeves. The movement of the threaded sleeves is transmitted via connecting means to the deformable sub-frame, whose elastic properties allow the width of the deformable sub-frame to be adjusted transversely to the traveling direction.

This is done in the manner described both in the case of a single soil processing unit and in the case of a plurality of soil processing units. In the case of a plurality of soil processing units, a rotation of the pipe about its longitudinal axis deforms the deformable sub-frames in an identical manner, thus changing the extent of the plurality of deformable sub-frames transversely to the traveling direction in an identical manner. This embodiment also takes into account the fact that modern agricultural cultivators have a width of several meters, and as a result a plurality of lanes between rows of cultivated plants can be worked simultaneously in one operation. With the described embodiment, all threaded sleeves are moved synchronously and thus all deformable sub-frames are deformed synchronously. A change in conditions or crop type of the cultivated area perceived by the farmer on the tractor can thus be reacted to immediately with a corresponding adjustment of the width of all deformable sub-frames.

Particularly preferably, the at least one soil processing unit arranged on the frame has a first and a second harrow tine, the first and the second harrow tine being connected to the deformable sub-frame of the respective soil processing unit. Harrow tines serve, on the one hand, to break up the clods and chunks of soil detached from the cultivator sweeps and, on the other hand, to pull the weeds to the surface of the soil. In addition, the harrow tines serve to break up compacted soil in an area relatively close to the crops. This area is usually not reached by the cultivator sweeps because the risk of damage to the crop by the cultivator sweeps is too great. Normally, no adjustment of the distance between the harrow tines is necessary, since the distance between the rows of cultivated plants is predetermined by the seeding and is therefore essentially always the same.

However, with regard to controlling weeds that grow particularly close to the crop plants, it is of particular advantage to move the harrow tines as close as possible along the row of crop plants. To avoid damaging the crop in the process, care must be taken to position the harrow tines accurately. By providing two harrow tines, both rows of cultivated plants adjacent to the respective soil processing unit can be cleared of weeds. By connecting the harrow tines to the deformable sub-frame, an adjustment of the distance between the two harrow tines can be made.

Particularly preferably, the first harrow tine is connected to a portion of the deformable sub-frame disposed on one side of the lane centerline and the second harrow tine is connected to a portion of the deformable sub-frame disposed on the opposite side of the lane centerline. Thus, a deformation of the deformable sub-frame can be particularly well converted into a change of the distance between the two harrow tines.

Preferably, the harrow tines are designed to be pivotable in a manner known per se, an adjusting device being provided which is associated with the harrow tines and by means of which the pretension of the harrow tines can be adjusted. Advantageously, this adjustment device consists of a wire or cord which is attached to the harrow tines, is deflected over a frame pipe and is attached to a further frame pipe. By rotating the frame pipe, the wire or cord is wound around the frame pipe and thereby exerts a corresponding tensile force on the harrow tine. In particular, if a drive unit is associated with such an adjustment device, the drive unit being especially preferably an electric or hydraulic actuator that can be controlled by means of a control unit, the pre-tensioning of the harrow tines and thus the adjustment of the tine pressure can also be carried out from the tractor during tillage. If necessary, the tine pressure can be easily and quickly adjusted to the prevailing conditions on the field, whereby the tillage operation does not need to be interrupted.

Under certain circumstances, it may also be the case that the harrow tines are not to be used during tillage. In such a case, the harrow tines are manually bent upwards against the spring force and fixed in a corresponding holding device. If required, the harrow tines can be released from the holding device and used again for soil cultivation in the manner described.

According to a further preferred embodiment, each soil processing unit has a first cultivator sweep, a second cultivator sweep and a third cultivator sweep. Particularly preferably, the first, second and third cultivator sweeps are arranged offset from one another in the traveling direction and transversely to the traveling direction in such a way that the cultivator sweeps form an isosceles triangle. The first cultivator sweep is arranged in the area of the lane centerline and forms the leading or trailing tip of the isosceles triangle in the traveling direction. Such an arrangement of the cultivator sweeps makes it possible to cultivate the soil over the entire width of the lane between two rows of cultivated plants.

Alternatively, tillage of the soil can be performed on both sides of a row of crops. In this case, the soil processing unit is guided vertically above a row of crops. In this case, in order not to damage the plants during cultivation, the first cultivator sweep is not used, and cultivation is carried out only with the second and third cultivator sweeps, which cultivate the soil to the left and right of the row of crops, respectively. It is clear to the person skilled in the art that in this case two depth guide wheels must be mounted, which are moved to both sides of the plant row. Likewise, it is clear to the skilled person that when the soil is worked on both sides of a row of crops, the optional cultivator sweeps provided on the soil processing unit must be positioned and aligned accordingly.

According to another particularly preferred embodiment of the present invention, the second and third cultivator sweeps are connected to the deformable sub-frame of the respective processing unit by one or more connecting means. By connecting the two cultivator sweeps, which are not arranged in the area of the lane centerline, to the deformable sub-frame, an adjustment of the distance between the two cultivator sweeps can be made. Thus, an adaptation of the width of the area between the rows of cultivated plants worked by the cultivator sweeps to the conditions at a specific place of use can be made.

Preferably, a first colter, a second colter, a third colter and a fourth colter are arranged on each soil processing unit, with the first and second colters respectively forming a front pair of colters and the third and fourth colters respectively forming a rear pair of colters. Preferably, the colters are disc colters. The first colter is connected to the deformable sub-frame by a first auxiliary connecting means, the second colter is connected to the deformable sub-frame by a second auxiliary connecting means, the third colter is connected to the deformable sub-frame by a third auxiliary connecting means, and the fourth colter is connected to the deformable sub-frame by a fourth auxiliary connecting means. Preferably, the two colters of the front pair of colters are arranged on different sides of the lane centerline and the two colters of the rear pair of colters are arranged on different sides of the lane centerline.

As usual, the disc colters of the front pair of colters are set to remove soil from the row of plants and the disc colters of the rear pair of colters are set to convey soil to the rows of plants. Particularly preferably, the discs can be mounted on the soil cultivator without tools by means of a cogwheel-like plug-in system with locking pin. This allows the angle of attack of the disc colters to be varied.

By connecting the colters to the deformable sub-frame, an adjustment can be made to the distance between the two colters of a pair of colters. Thus, the distance of the colters from each other can be adapted to the width of the area worked by the cultivator sweeps between the rows of cultivated plants.

Preferably, two auxiliary connecting means by which the individual colters are connected to the deformable sub-frame are each connected to a respective ring provided centrally within the deformable sub-frame. In this case, a front colter and a rear colter, which are arranged on different sides of the lane centerline, are each connected to a ring. The rings are designed to be rotatable relative to each other, which ensures the mobility required to change the distance between the colters of a pair of colters. However, four rings may also be provided, in which case each colter is designed to be movable individually and independently of the other colters.

The rings are placed around a vertically aligned support foot, which attaches a depth guide wheel, each associated with a processing unit, to the soil cultivator in a vertically displaceable manner. These depth guide wheels provide the necessary stability for the entire soil cultivator. In addition, a frame pipe is advantageously arranged in a corresponding recess in the bearing block of the tractor in a form-fit and force-fit manner, which also dissipates the forces occurring during use of the soil cultivator. Finally, struts connecting the frame pipes to each other may be provided, further improving the stability of the frame.

According to another preferred embodiment, one or more telescoping rods may be provided to which additional tools for tillage may be attached. For example, additional cultivator sweeps may be provided. Such telescopic rods preferably extend in the traveling direction F and/or transversely to the traveling direction F. Due to their telescopic nature, the rods can easily follow the movements of the deformable sub-frame. If the extent of the deformable sub-frame is increased transverse to the traveling direction, the telescopic rods arranged in the traveling direction slide into one another and shorten in this way. At the same time, the telescopic rods arranged transverse to the traveling direction pull apart and lengthen in this way. If the extent of the deformable sub-frame is reduced transversely to the traveling direction, the telescopic rods arranged transversely to the traveling direction push into one another and shorten in this way. At the same time, the telescopic rods arranged in the traveling direction pull apart and lengthen in this way.

As already explained above, according to a particularly preferred embodiment, both the harrow tines are connected to the deformable sub-frame, as are the cultivator sweeps and the colters. In this case, therefore, it is possible to adjust the distance between the two harrow tines, it is possible to adjust the width of the area worked by the cultivator sweeps, and it is possible to ensure adjustment of the distance between the two colters of a pair of colters. Since these individual elements are attached to the deformable sub-frame at different points, a certain change in the width of the deformable sub-frame causes a different degree of change in the distance between the harrow tines, between the cultivator sweeps and between the colters. By fixing the different elements accordingly, it is thus possible to take into account the fact that it can be advantageous if the distance between the individual elements changes to a different extent. Indeed, if the distance between the colters of a pair of colters and the distance between the harrow tines are changed more than the distance between the cultivator sweeps, it is certainly avoided that the cultivator sweeps are guided too close to the crop plants and possibly damage them.

In practice, a relatively large change in the distance between the colters of a pair of colters is often desired, while the distance between the second and third cultivator sweeps tends to be made to a lesser extent. An even smaller change in spacing is usually desired for the harrow tines.

In addition, individual elements can also be fixed so that their spacing relative to each other remains unchanged. This can be provided in particular for the harrow tines, since these are often provided at a fixed distance from one another. In this case, the harrow tines are not fastened to the deformable sub-frame but, for example, to the support foot provided in the center of the soil processing unit. Alternatively, the harrow tines can also be attached directly to a frame pipe or to another structural element of the frame.

### BRIEF DESCRIPTION OF THE DRAWINGS

The invention will be explained in more detail below with reference to specific embodiments in connection with the drawings. However, it is expressly noted that the invention is not intended to be limited to the examples given. The following are shown:

FIG. 1 is a schematic representation of a top view of a soil processing unit of a soil cultivator;

FIG. 2 is a schematic representation of a top view of a further embodiment of the soil processing unit of a soil cultivator;

FIG. 3 is a schematic representation of a top view of a soil cultivator with a tractor;

FIG. 4 is a schematic representation of a top view of a further embodiment of the soil processing unit of a soil cultivator;

FIG. 5 is a schematic representation of a top view of a further embodiment of the soil processing unit of a soil cultivator;

FIG. 6 is a schematic representation of a top view of a further embodiment of a soil cultivator with a tractor.

FIGS. 7A-7F are schematic representations of top views of further embodiments of deformable frame elements.

### DETAILED DESCRIPTION OF THE PREFERRED EMBODIMENTS

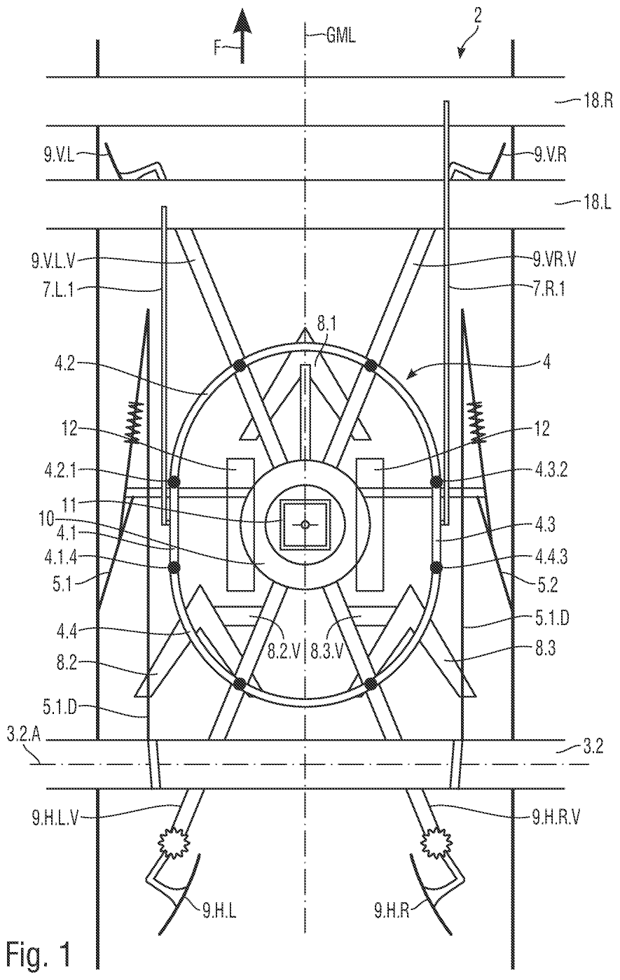

FIG. 1 shows in schematic view a top view of a soil processing unit 2 of a soil cultivator for mechanical weed control between rows of cultivated plants according to the invention. The soil cultivator has a frame attachable to a tractor for movement along a traveling direction F, the frame being indicated only by the frame pipe 3.2. Further elements of the frame are not necessary for the description of the invention and are therefore not shown in the figure. The frame pipe 3.2 has a longitudinal axis 3.2.A, wherein the longitudinal axis 3.2.A is arranged transversely to the traveling direction F.

In the embodiment shown in FIG. 1, the soil cultivation is carried out in a lane between two rows of cultivated plants, the lane having a lane centerline GML defined parallel to the travel direction F. However, as mentioned above, it is also possible to perform tillage to the left and right of a row of crops. In this case, however, a first cultivator sweep 8.1, described in more detail below, must be removed.

The soil processing unit 2 includes a frame-like element or deformable sub-frame 4 constructed from a first 4.1, a second 4.2, a third 4.3 and a fourth sub-element 4.4, the first 4.1 and the third sub-element 4.3 being formed from a linear piece of spring steel, while the second 4.2 and the fourth sub-element 4.4 are formed from a piece of spring steel bent into a U-shape. The individual sub-elements are fixedly connected to each other and together form a deformable sub-frame 4 made of elastic spring steel. In a top view of the soil processing unit 2, it can be seen that the deformable sub-frame 4 has an approximately oval shape with two linear sections.

The soil cultivator comprises a first, movably configured adjusting means or first adjusting member 18.L and a second, movably configured adjusting means or second adjusting member 18.R. The first adjusting member 18.L is connected to the deformable sub-frame 4 by the rod part 7.L.1 in the area of the first sub-element 4.1. The second adjusting member 18.R is connected to the deformable sub-frame 4 by the rod part 7.R.1 in the region of the third sub-element 4.3.

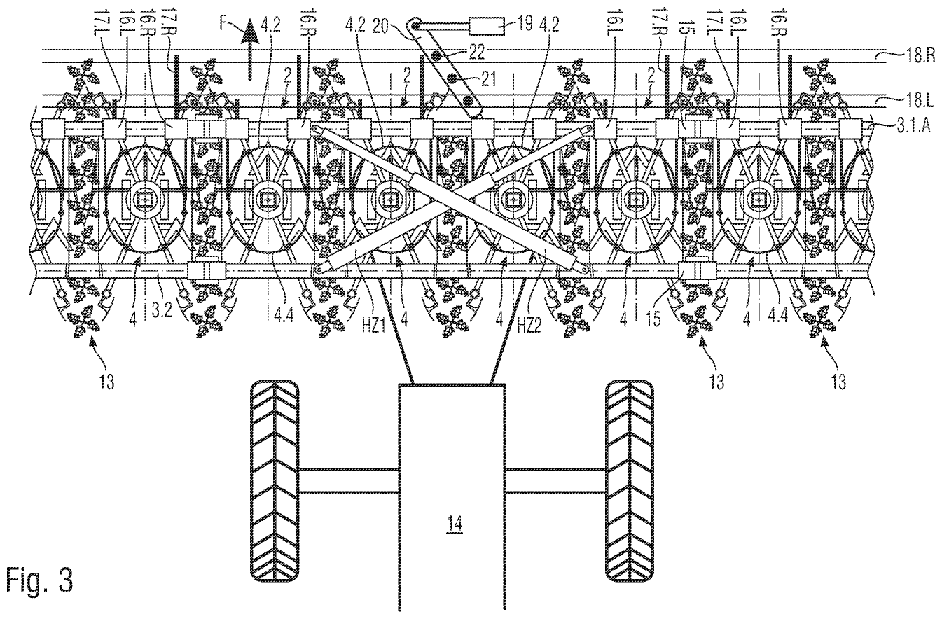

By means of an antiparallel movement of the first adjusting member 18.L and the second adjusting member 18.R, which is explained in more detail below in connection with FIG. 3, the rod parts 7.L.1, 7.R.1 are moved either towards or away from each other. As a result, the deformable sub-frame 4 is deformed, in particular in the area of the curved sub-elements 4.2, 4.4, so that the extent or width of the deformable sub-frame 4 changes transversely to the traveling direction F.

The movement of the first 18.L and the second adjusting members 18.R is caused by an adjusting unit 19 (see FIG. 3) acting on the adjusting members via a movement transmission means 20 which in the embodiment shown comprises a transmission linkage or movement transmission 20. In the embodiment shown, the adjusting unit 19 is a hydraulic actuator which can be controlled by means of a control unit. In the embodiment shown, the rod parts 7.L.1 and 7.R.1, the first and second adjusting members 18.L and 18.R, the transmission 20 and the adjusting unit 19 comprise means for deforming or adjusting the width or extent of the frame like element or deformable sub-frame.

The soil processing unit 2 has a first 5.1 and a second harrow tine 5.2, the first 5.1 and the second harrow tine 5.2 being arranged on different sides of the lane centerline GML. The first harrow tine 5.1 and the second harrow tine 5.2 are each connected to the frame pipe 3.2 by a wire 5.1.D, 5.2.D. By rotating the frame pipe 3.2, the wires 5.1.D, 5.2.D are wound around the frame pipe and a corresponding tensile force is exerted on the harrow tines 5.1, 5.2. This allows the pretension of the harrow tines 5.1, 5.2 to be adjusted.

The first harrow tine 5.1 is connected to the linear first sub-element 4.1 of the deformable sub-frame 4, while the second harrow tine 5.2 is connected to the linear third sub-element 4.3 of the deformable sub-frame 4. By connecting the harrow tines 5.1, 5.2 to one sub-element each of the deformable sub-frame 4, an adjustment of the distance between the two harrow tines 5.1, 5.2 can be made. This brings particular advantages with regard to the control of weeds growing particularly close to the crop plants, since the harrow tines 5.1, 5.2 can be moved very close along the row of crop plants. Damage to the crop plants can be avoided, as precise positioning of the harrow tines relative to the crop plants can be made by changing the width of the deformable sub-frame 4.

A first cultivator sweep 8.1, a second cultivator sweep 8.2 and a third cultivator sweep 8.3 are also arranged on the soil processing unit 2, wherein the second cultivator sweep 8.2 and the third cultivator sweep 8.3 are arranged on different sides of the lane centerline (GML). The cultivator sweeps 8.1, 8.2, 8.3 are arranged offset from one another both in the traveling direction F and transversely to the traveling direction F in such a way that they form an isosceles triangle, the first cultivator sweep 8.1 arranged in the region of the lane centerline GML forming the apex of the isosceles triangle leading in the traveling direction.

It can be seen from FIG. 1 that the second cultivator sweep 8.2 and the third cultivator sweep 8.3 are connected to the fourth sub-element 4.4 of the deformable sub-frame 4 by a connecting means comprising a connecting member 8.2.V, 8.3.V in each case and by a further auxiliary connecting means comprising a connecting member 9.H.L.V, 9.H.R.V in each case. Thereby, the two cultivator sweeps 8.2, 8.3 are connected to the fourth sub-element of the deformable sub-frame 4 on different sides of the lane center line GML. By this connection of the cultivator sweeps 8.2, 8.3 with the fourth sub-element 4.4 of the deformable sub-frame 4 on different sides of the lane centerline GML, an adjustment of the distance of the two cultivator sweeps 8.2, 8.3 from each other can be made using the means for deforming or adjusting the width or extent of the deformable sub-frame. Thus, an adaptation of the width of the area worked by the cultivator sweeps 8.1, 8.2, 8.3 between the rows of cultivated plants to the conditions at a specific site of use can be made.

The soil processing unit 2 further comprises a first colter 9.V.L, a second colter 9.V.R, a third colter 9.H.R and a fourth colter 9.H.L, wherein the first 9.V.L and the second colter 9.V.R form a front pair of colters 9.V.L, 9.V.R and the third 9.H.R and the fourth colter 9.H.L form a rear pair of colters 9.H.L, 9.H.R. Thereby, the two colters of the front colter pair 9.V.R, 9.V.L are arranged on different sides of the lane centerline GML and the two colters of the rear colter pair 9.H.R, 9.H.L are arranged on different sides of the lane centerline GML.

The first colter 9.V.L is connected to the second sub-element 4.2 of the deformable sub-frame 4 by a first auxiliary connecting means comprising a first auxiliary connecting member 9.V.L.V, while the second colter 9.V.R is also connected to the second sub-element 4.2 of the deformable sub-frame 4 by a second auxiliary connecting means comprising an auxiliary connecting member 9.V.R.V. In this case, the two colters 9.V.L, 9.V.R are connected to the second sub-element 4.2 of the deformable sub-frame 4 on different sides of the lane centerline GML. By this connection of the colters 9.V.L, 9.V.R with the second sub-element 4.2 of the deformable sub-frame 4 on different sides of the lane centerline GML, an adjustment of the distance of the two colters 9.V.L, 9.V.R from each other can be made using the means for deforming or adjusting the width or extent of the deformable sub-frame. Thus, the distance of the colters from each other can be adjusted to the width of the area worked by the cultivator sweeps between the rows of cultivated plants.

Similarly, third colter 9.H.R is connected to fourth sub-element 4.4 of deformable sub-frame 4 by third auxiliary connecting means comprising a third auxiliary connecting member 9.H.R.V, while fourth colter 9.H.L is connected to fourth sub-element 4.4 of deformable sub-frame 4 by fourth auxiliary connecting means comprising a fourth auxiliary connecting member 9.H.L.V as well. Thereby, the two colters 9.H.L, 9.H.R are connected to the fourth sub-element 4.4 of the deformable sub-frame 4 on different sides of the lane centerline GML. By this connection of the colters 9.H.L, 9.H.R with the fourth sub-element 4.4 of the deformable sub-frame 4 on different sides of the lane centerline GML, an adjustment of the distance of the two colters 9.H.L, 9.H.R from each other can be made using the means for deforming or adjusting the width or extent of the deformable sub-frame. Thus, the distance of the colters from each other can be adjusted to the width of the area worked by the cultivator sweeps between the rows of cultivated plants.

The auxiliary connecting members 9.V.L.V, 9.V.R.V, 9.H.R.V, 9.H.L.V, by which the individual colters are connected to the sub-elements 4.2, 4.4 of the deformable sub-frame 4, are each connected to a ring 10 provided centrally in the deformable sub-frame. In one embodiment, a front colter and a rear colter, which are arranged on different sides of the lane centerline, are connected to the same ring 10. The rings 10 are designed to be rotatable relative to each other, which ensures the mobility required to change the distance between the colters of a pair of colters.

The two rings 10 are placed around a vertically aligned support foot 11, which attaches a depth guide wheel 12, each associated with a soil processing unit 2, to the soil cultivator in a vertically displaceable manner.

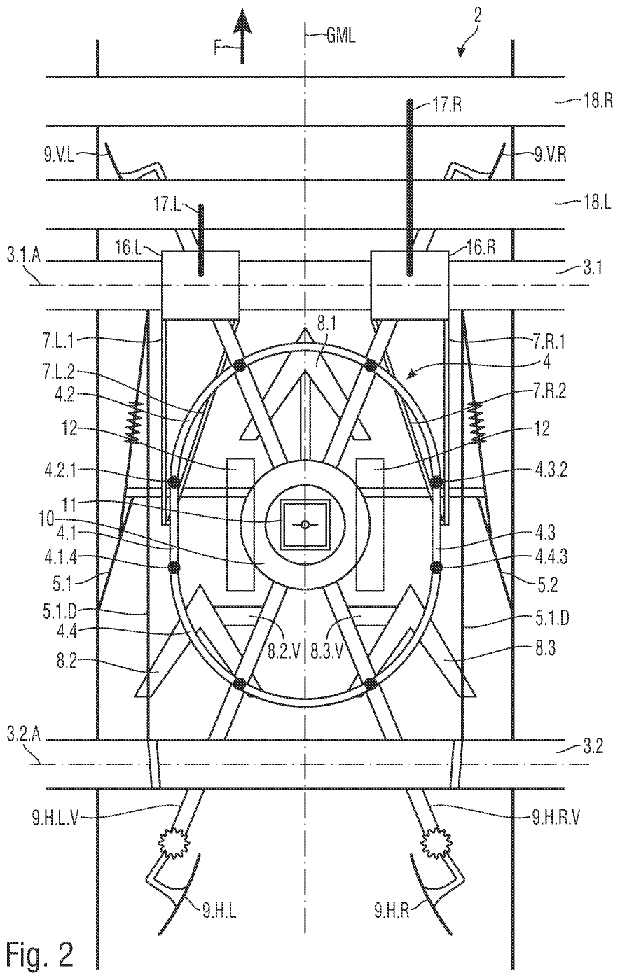

FIG. 2 shows in schematic view a top view of a further embodiment of a soil processing unit 2 of a soil cultivator for mechanical weed control between rows of cultivated plants according to the invention. The soil cultivator has a frame attachable to a tractor for movement along a traveling direction F, the frame being indicated only by the frame pipe 3.2. Further elements of the frame are not necessary for the description of the invention and are therefore not shown in the figure. The frame pipe 3.2 has a longitudinal axis 3.2.A, wherein the longitudinal axis 3.2.A is arranged transversely to the traveling direction F.

In the embodiment shown in FIG. 2, the soil cultivation takes place in a lane between two rows of cultivated plants, the lane having a lane centerline GML defined parallel to the travel direction F. However, as mentioned above, it is also possible to perform tillage to the left and right of a row of crops. In this case, however, the first cultivator sweep 8.1, described in more detail below, must be removed.

The soil processing unit 2 has a deformable sub-frame 4 constructed from a first 4.1, a second 4.2, a third 4.3 and a fourth sub-element 4.4, the first 4.1 and the third sub-element 4.3 being formed from a linear piece of spring steel, while the second 4.2 and the fourth sub-element 4.4 are formed from a piece of spring steel bent into a U-shape. The individual sub-elements are firmly connected to each other and together form a deformable sub-frame 4 consisting of elastic spring steel. In a top view of the soil processing unit 2, it can be seen that the deformable sub-frame 4 has an approximately oval shape with two linear sections.

The soil processing unit 2 has a pipe 3.1 arranged transversely to the traveling direction F, wherein a first guide sleeve 16.L and a second guide sleeve 16.R are arranged on the pipe 3.1. The first guide sleeve 16.L is provided on its outer side with a first force transmission means in the form of a first elongated rod part 17.L and the second guide sleeve 16.R is provided on its outer side with a second force transmission means in the form of a second elongated rod part 17.R. The first and second rod parts 17.L and 17.R have different lengths.

The first guide sleeve 16.L is connected to the deformable sub-frame 4 by two rod parts 7.L.1, 7.L.2 in the area of the first sub-element 4.1, while the second guide sleeve 16.R is connected to the deformable sub-frame 4 by two rod parts 7.R.1, 7.R.2 in the area of the third sub-element 4.3.

The soil cultivator comprises a first movably configured adjusting means comprising a first adjusting member 18.L, wherein the first adjusting member 18.L is fixedly connected to the first elongated rod part 17.L, and a second movably configured adjusting means comprising a second adjusting member 18.R, wherein the second adjusting member 18.R is fixedly connected to the second elongated rod part 17.R.

By means of an antiparallel movement of the first adjusting member 18.L and the second adjusting member 18.R, which is explained in more detail below in connection with FIG. 3, the guide sleeves 16.L, 16.R are moved either towards each other or away from each other. As a result, the deformable sub-frame 4 is deformed, in particular in the region of the curved sub-elements 4.2, 4.4, so that the extent of the deformable sub-frame 4 changes transversely to the traveling direction F.

The movement of the first and the second adjusting members 18.L and 18.R is caused by an adjusting unit 19 (see FIG. 3) acting on the first and second adjusting members 18.L and 18.R via a movement transmission means comprising transmission 20. In the embodiment shown, the adjusting unit 19 is a hydraulic actuator which can be controlled by means of a control unit.

In the embodiment shown in FIG. 2, the rod parts 7.L.1 and 7.R.1, the guide sleeves 16.L and 16.R, the first and second elongated rod parts 17.L and 17.R, the adjusting members 18.L and 18.R, the movement transmission 20 and the adjusting unit 19 comprise means for deforming or adjusting the width or extent of the deformable sub-frame or deformable sub-frame 4.

The soil processing unit 2 has a first 5.1 and a second harrow tine 5.2, the first 5.1 and the second harrow tine 5.2 being arranged on different sides of the lane centerline GML. The first harrow tine 5.1 and the second harrow tine 5.2 are each connected to the frame pipe 3.2 by a wire 5.1.D, 5.2.D. By rotating the frame pipe 3.2, the wires 5.1.D, 5.2.D are wound around the frame pipe and a corresponding tensile force is exerted on the harrow tines 5.1, 5.2. This allows the pretension of the harrow tines 5.1, 5.2 to be adjusted.

The first harrow tine 5.1 is connected to the linear first sub-element 4.1 of the deformable sub-frame 4, while the second harrow tine 5.2 is connected to the linear third sub-element 4.3 of the deformable sub-frame 4. By connecting the harrow tines 5.1, 5.2 to one sub-element each of the deformable sub-frame 4, an adjustment of the distance between the two harrow tines 5.1, 5.2 can be made. This brings particular advantages with regard to the control of weeds growing particularly close to the crop plants, since the harrow tines 5.1, 5.2 can be moved very close along the row of crop plants. Damage to the crop plants can be avoided, as precise positioning of the harrow tines relative to the crop plants can be made by changing the width of the deformable sub-frame 4.

A first cultivator sweep 8.1, a second cultivator sweep 8.2 and a third cultivator sweep 8.3 are also arranged on the soil processing unit 2, wherein the second cultivator sweep 8.2 and the third cultivator sweep 8.3 are arranged on different sides of the lane centerline (GML). The cultivator sweeps 8.1, 8.2, 8.3 are arranged offset from one another both in the traveling direction F and transversely to the traveling direction F in such a way that they form an isosceles triangle, the first cultivator sweep 8.1 arranged in the region of the lane centerline GML forming the apex of the isosceles triangle leading in the traveling direction.

It can be seen from FIG. 1 that the second cultivator sweep 8.2 and the third cultivator sweep 8.3 are connected to the fourth sub-element 4.4 of the deformable sub-frame 4 by a connecting means comprising connecting member 8.2.V, 8.3.V in each case and by a further auxiliary connecting means comprising auxiliary connecting member 9.H.L.V, 9.H.R.V in each case. Thereby, the two cultivator sweeps 8.2, 8.3 are connected to the fourth sub-element of the deformable sub-frame 4 on different sides of the lane center line GML. By this connection of the cultivator sweeps 8.2, 8.3 with the fourth sub-element 4.4 of the deformable sub-frame 4 on different sides of the lane centerline GML, an adjustment of the distance of the two cultivator sweeps 8.2, 8.3 from each other can be made. Thus, an adaptation of the width of the area worked by the cultivator sweeps 8.1, 8.2, 8.3 between the rows of cultivated plants to the conditions at a specific site of use can be made.

The soil processing unit 2 further comprises a first colter 9.V.L, a second colter 9.V.R, a third colter 9.H.R and a fourth colter 9.H.L, wherein the first 9.V.L and the second colter 9.V.R form a front pair of colters 9.V.L, 9.V.R and the third 9.H.R and the fourth colter 9.H.L form a rear pair of colters 9.H.L, 9.H.R. Thereby, the two colters of the front colter pair 9.V.R, 9.V.L are arranged on different sides of the lane centerline GML and the two colters of the rear colter pair 9.H.R, 9.H.L are arranged on different sides of the lane centerline GML.

The first colter 9.V.L is connected to the second sub-element 4.2 of the deformable sub-frame 4 by a first auxiliary connecting means comprising first auxiliary connecting member 9.V.L.V, while the second colter 9.V.R is also connected to the second sub-element 4.2 of the deformable sub-frame 4 by a second auxiliary connecting means comprising a second auxiliary connecting member 9.V.R.V. In this case, the two colters 9.V.L, 9.V.R are connected to the second sub-element 4.2 of the deformable sub-frame 4 on different sides of the lane centerline GML. By this connection of the colters 9.V.L, 9.V.R with the second sub-element 4.2 of the deformable sub-frame 4 on different sides of the lane centerline GML, an adjustment of the distance of the two colters 9.V.L, 9.V.R from each other can be made using the means for deforming or adjusting the width or extent of the deformable sub-frame of deformable sub-frame. Thus, the distance of the colters from each other can be adjusted to the width of the area worked by the colters between the rows of cultivated plants.

Similarly, third colter 9.H.R is connected to fourth sub-element 4.4 of deformable sub-frame 4 by third auxiliary connecting means comprising third auxiliary connecting member 9.H.R.V, while fourth colter 9.H.L is connected to fourth sub-element 4.4 of deformable sub-frame 4 by fourth auxiliary connecting means comprising fourth auxiliary connecting member 9.H.L.V as well. Thereby, the two colters 9.H.L, 9.H.R are connected to the fourth sub-element 4.4 of the deformable sub-frame 4 on different sides of the lane centerline GML. By this connection of the colters 9.H.L, 9.H.R with the fourth sub-element 4.4 of the deformable sub-frame 4 on different sides of the lane centerline GML, an adjustment of the distance of the two colters 9.H.L, 9.H.R from each other can be made using the means for deforming or adjusting the width or extent of the deformable sub-frame of deformable sub-frame. Thus, the distance of the colters from each other can be adjusted to the width of the area worked by the colters between the rows of cultivated plants.

The auxiliary connecting members 9.V.L.V, 9.V.R.V, 9.H.R.V, 9.H.L.V, by which the individual colters are connected to the sub-elements 4.2, 4.4 of the deformable sub-frame 4, are each connected to a ring 10 provided centrally in the deformable sub-frame. In each case, a front colter and a rear colter, which are arranged on different sides of the lane centerline, are connected to the same ring 10. The rings 10 are designed to be rotatable relative to each other, which ensures the mobility required to change the distance between the colters of a pair of colters.

The two rings 10 are placed around a vertically aligned support foot 11, which attaches a depth guide wheel 12, each associated with a soil processing unit, to the soil cultivator in a vertically displaceable manner.

FIG. 3 shows a schematic view of a soil cultivator according to the invention with a tractor 14. In the embodiment shown, the soil cultivator consists of a total of twelve soil processing units 2, of which six soil processing units 2 are shown in their entirety and two further soil processing units are shown in part. Each of these twelve soil processing units 2 is constructed as described in connection with FIG. 2. The pipe 3.1 and the frame pipe 3.2 are each divided into three sections which are connected to each other by universal joints 15. Four soil processing units 2 are provided on each of the sections. The frame is indicated only by the frame pipe 3.2. Further elements of the frame are not necessary for the description of the invention and are therefore not shown in FIG. 3.

At each of the two opposite ends of the soil cultivator a modified soil processing unit (not shown) is provided, which only has colters, harrow tines and cultivator sweeps on its side facing the other soil processing units. The other elements are missing. This ensures that the two outermost rows of cultivated plants being worked in the particular operation are cleared of weeds from both sides. The lane following this outer row of crops is worked in two successive passes with the soil cultivator in each case in the area located on one side of the lane centerline.

The two hydraulic cylinders HZ1, HZ2 are connected to each other by frame parts (not shown). These hydraulic cylinders are used to adjust the position of the soil cultivator relative to the tractor when working on a slope.

The two outer sections of the soil cultivator can be folded up into a vertical position by another hydraulic system (not shown), reducing the overall width of the soil cultivator by ⅔. This makes it possible to drive the tractor with soil cultivator on public roads without any problems.

As shown in FIG. 3, a number of deformable sub-frames 4 corresponding to the number of soil processing units 2 are provided. The pipe 3.1 therefore has twelve first guide sleeves 16.L and twelve second guide sleeves 16.R, each of the first guide sleeves 16.L being connected to the first adjusting member 18.L via a respective first elongated rod part 17.L, and each of the second guide sleeves 16.R being connected to the second adjusting member 18.R via a respective second elongated rod part 17.R. The pipe 3.1 has twelve first guide sleeves 16.L and twelve second guide sleeves 16.R, each of the first guide sleeves 16.L being connected to the first adjusting member 18.L via a respective second elongated rod part 17.R.

By means of the guide sleeves 16.L, 16.R provided on the pipe 3.1 and their connection to the first 4.1 and the third sub-element 4.3 of the deformable sub-frame 4, it is achieved that a movement of the guide sleeves 16.L, 16.R is converted into a deformation of the deformable sub-frame 4. In this case, the movement of the guide sleeves 16.L, 16.R is transmitted to the deformable sub-frame 4 via the rod parts 7.L.1, 7.L.2, 7.R.1, 7.R.2, the elastic properties of which enable the width of the deformable sub-frame 4 to be adjusted transversely to the traveling direction F. The movement of the guide sleeves 16.L, 16.R is caused by the two adjusting members 18.L, 18.R, one of which is connected to each guide sleeve. In this case, the movement of the adjusting members 18.L, 18.R is transmitted to the guide sleeves 16.L, 16.R via elongated rod parts 17.L, 17.R in each case.

The change in the extent of the deformable sub-frame 4 transversely to the traveling direction F can be affected particularly easily with the embodiment shown, since the movement of the first guide sleeve 16.L and the second guide sleeve 16.R takes place in opposite directions. As can be seen from FIG. 3, the pipe 3.1 to which the guide sleeves 16.L, 16.R are attached is arranged transversely to the traveling direction F. This means that the movement of the guide sleeves 16.L and 16.R can be affected in opposite directions. As a result, the movement of the guide sleeves 16.L, 16.R is fully transferred into a change in the extent of the deformable sub-frames 4 transverse to the traveling direction F.

The transmission of the movement of the adjusting members 18.L, 18.R via the first and second elongated rod parts 17.L, 17.R to the guide sleeves 16.L, 16.R is also realized in a particularly advantageous manner by the embodiment shown. The first adjusting member 18.L is movable transversely to the traveling direction F and the second adjusting member 18.R is movable transversely to the traveling direction F. This means that the movement of the adjusting members 18.L, 18.R via the force transmission means comprising the first and second elongated rod parts 17.L, 17.R can be converted directly and completely into a movement of the first guide sleeves 16.L and the second guide sleeves 16.R oriented transversely to the traveling direction F. If each pair of guide sleeves 16.L, 16.R moves towards each other, the extent of all deformable sub-frames 4 transverse to the traveling direction F is reduced in the same way. If in each case one pair of guide sleeves 16.L, 16.R moves away from each other, the extent of all deformable sub-frames 4 transverse to the traveling direction F is increased in the same way.

The movement of the adjusting members 18.L, 18.R is caused by the adjusting unit 19, wherein the first guide sleeve 16.L and the second guide sleeve 16.R are moved by the movement of the first and the second adjusting members 18.L, 18.R, and the deformable sub-frames 4 are deformed by the movement of the first and the second guide sleeves 16.L and 16.R respectively in such a way that the extent of the deformable sub-frames 4 changes transversely to the traveling direction F.

With the aid of the adjusting unit 19, which can be actuated by means of a control unit, the movement of the first and second adjusting members 18.L, 18.R can also be affected from the tractor during tillage. The width of deformable sub-frames 4 can thus be easily and quickly adjusted to the prevailing conditions on the field as required, whereby the soil cultivation process need not be interrupted.

The movement transmission 20 has an elongated shape and is fixedly but rotatably connected to the frame at the pivot point 21. The adjusting unit 19 is connected to the elongated movement transmission 20 in the region of one end thereof. A movement caused by the adjusting unit 19 is thus converted into a rotation of the movement transmission 20. In a manner known to the skilled person, in this case the adjusting unit 19 is pivotably mounted on the frame and can thus follow the deflection of the movement transmission 20 due to its rotational movement. In the movement transmission 20, in a manner known to the skilled person, at least one elongated hole 22 is provided, in which a pin or other connecting means of the second adjusting member 18.R is received. Due to its design as an elongated hole 22, the movement transmission 20 can perform a rotational movement without causing a movement of the adjusting member 18.R in the traveling direction F.

Thus, a linear movement of the first and the second adjusting members 18.L and 18.R oriented transversely to the traveling direction F is affected by the adjusting unit 19, the movement of the first adjusting member 18.L being oriented antiparallel to the movement of the second adjusting member 18.R. The movement of the first adjusting member 18.L is oriented transversely to the traveling direction F. In this way, the movement of the adjusting members 18.L and 18.R is converted directly proportionally into a corresponding change in the extent of deformable sub-frames 4 transversely to the traveling direction F.

The adjusting unit 19 can also be a manually operated element. In this case, the movement of the first and second adjusting members 18.L and 18.R cannot be affected from the tractor during soil cultivation. Rather, in order to adjust the extent of the deformable sub-frames 4 to the respective conditions on the field, the tillage operation must be interrupted.

In this case, the movement transmission means can be designed, for example, as a gear wheel which engages in a section designed as a toothed rack on the first and on the second adjusting members 18.L and 18.R. The gear wheel is designed as a toothed rack. A rotation of the gear wheel moves the two adjusting members 18.L and 18.R in antiparallel directions. The rotation of the gear wheel can be affected by manual pivoting of, for example, a lever-like element which is fixedly connected to the axis of rotation of the gear wheel. In addition, means for fixing the lever-like element and thus the gear wheel in a certain position may be provided.

Using this type of adjusting unit 19, a linear movement of the first 18.L and of the second adjusting members 18.R, oriented transversely to the traveling direction F, is affected, the movement of the first adjusting member 18.L being oriented antiparallel to the movement of the second adjusting member 18.R. In this way, the movement of the adjusting members 18.L and 18.R is converted directly proportionally into a corresponding change in the extent of deformable sub-frames 4 transversely to the traveling direction F.

FIG. 3 also shows several rows of cultivated plants 13. The tractor 14 moves the soil cultivator in the traveling direction parallel to the rows of cultivated plants. Each lane between two rows of cultivated plants is associated with a soil processing unit 2. When using the soil cultivator, the leading front colters create depressions of several centimeters in the soil. The three cultivator sweeps are pulled through the soil at a shallow depth, cutting through the roots of the weeds growing in the lane between the crops. The two harrow tines scrape up the soil near the crops, simultaneously breaking up the clods and chunks of soil dislodged by the cultivator sweeps and pulling the weeds to the soil surface. Compacted soil near the crops is broken up by the harrow tines in the process. The two trailing colters move soil toward the crops, filling in the initially created depressions and accumulating soil near the crops.

Since, as described above, each of the twelve control units has two harrow tines, three cultivator sweeps and four colters, which are all moved together with the respective subframe, the complete tillage between the rows of cultivated plants can be adapted to the specific local conditions. Both the distance between the harrow tines, as well as the distance between the colters and the distance between the cultivator sweeps can be adapted to the field to be worked.

As already mentioned, a plurality of soil processing units 2 with a plurality of deformable sub-frames 4 are arranged on the frame, wherein the pipe 3.1 has a number of guide sleeves 16.L, 16.R matched to the number of soil processing units 2. A first guide sleeve 16.L and a second guide sleeve 16.R are provided for each soil processing unit 2. By a movement of the first adjusting member 18.L and the second adjusting member 18.R, the deformable sub-frames 4 are deformed in such a way that the extent of the plurality of deformable sub-frames 4 changes in an identical manner transversely to the traveling direction F. This allows a plurality of lanes between rows of cultivated plants to be processed simultaneously in a single operation. All first or second guide sleeves 16.L or 16.R are moved synchronously, whereby all deformable sub-frames 4 are deformed synchronously. A change in conditions or crop type of the cultivated area perceived by the farmer on the tractor can thus be immediately reacted to with a corresponding adjustment of the extent of all deformable sub-frames 4.

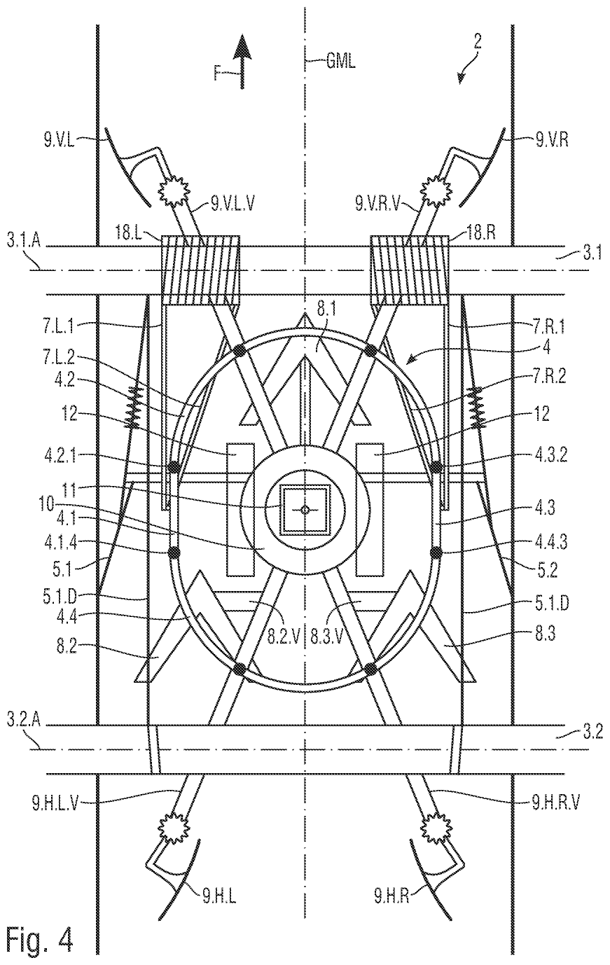

FIG. 4 shows in schematic view a top view of a further embodiment of a soil processing unit 2 of a soil cultivator for mechanical weed control in lanes between rows of cultivated plants according to the invention. The individual elements of the embodiment correspond as far as possible to the elements of the embodiment shown in FIG. 1. In this respect, reference is made to the above explanations.

In contrast to the embodiment according to FIG. 1, the pipe 3.1.A of the soil processing unit 2 shown in FIG. 4 has a left-handed external thread and a right-handed external thread, wherein the left-handed external thread is in engagement with a first threaded sleeve 18.L having a left-handed inner thread, and the right-handed external thread is in engagement with a second threaded sleeve 18.R having a right-handed inner thread. In the embodiment shown, the threaded sleeves 18.L and 18.R form the first and the second adjusting means, respectively.

The first threaded sleeve 18.L is connected to the deformable sub-frame 4 by two rod parts 7.L.1, 7.L.2 in the region of the first sub-element 4.1, while the second threaded sleeve 18.R is connected to the deformable sub-frame 4 by two rod parts 7.R.1, 7.R.2 in the region of the third sub-element 4.3.

When the pipe 3.3 is rotated about its longitudinal axis 3.3.A, the threaded sleeves 18.L, 18.R move either towards or away from each other. This movement deforms the frame-like element or deformable sub-frame 4 in such a way that the extent of the deformable sub-frame 4 changes transversely to the traveling direction F. The rotation of the pipe 3.3 about its longitudinal axis 3.3.A and thus the movement of the threaded sleeves 18.L and 18.R is affected by an adjusting unit (not shown) associated with the pipe 3.3, which is a hydraulic actuator controllable by means of a control unit. The exteriorly threaded pipe 3.3, the threaded sleeves 18.L and 18.R, the rod parts 7.L.1, 7.L.2 and 7.R.1 and 7.R.2 alone or in combination with an adjusting unit comprise deforming means for deforming or adjusting the width or extent of the deformable sub-frame or deformable sub-frame 4.

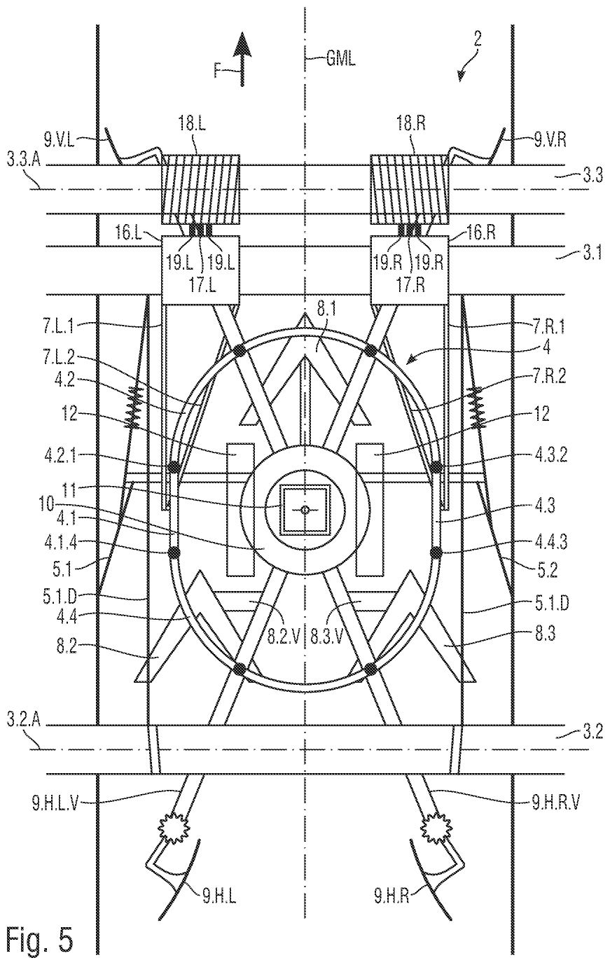

FIG. 5 shows in schematic representation a top view of a further embodiment of a soil processing unit 2 of a soil cultivator for mechanical weed control in lanes between rows of cultivated plants according to the invention.

The soil cultivator largely corresponds to the embodiment described in connection with FIG. 4. In contrast to the embodiment shown in FIG. 4, a second pipe 3.1 oriented transversely to the traveling direction F is additionally provided, the pipe 3.1 having a first guide sleeve 16.L and a second guide sleeve 16.R, the first guide sleeve 16.L and the second guide sleeve 16.R each being provided on their outer side with a pin-like protrusion 17.L, 17.R. The first threaded sleeve 18.L and the second threaded sleeve 18.R each have a fork-like pair of protrusions 19.L, 19.R on their outer surface, wherein the pin-like protrusion 17.L of the first guide sleeve 16. L is in engagement with the fork-like pair of protrusions 19.L of the first threaded sleeve 18.L, and the pin-like protrusion 17.R of the second guide sleeve 16.R is in engagement with the fork-like pair of protrusions 19.R of the second threaded sleeve 18.R. The second pipe 3.1 and the first and second guide sleeves 16.L and 16.R may be part of the deforming means.

The first threaded sleeve 18.L is connected to the deformable sub-frame 4 via the guide sleeve 16.L and the two rod parts 7.L.1, 7.L.2 in the region of the first sub-element 4.1, while the second threaded sleeve 18.R is connected to the deformable sub-frame 4 via the guide sleeve 16.R and the two rod parts 7.R.1, 7.R.2 in the region of the third sub-element 4.3.

As in the embodiment shown in FIG. 4, the pipe 3.3 of the soil processing unit 2 has a left-handed external thread and a right-handed external thread, the left-handed external thread being in engagement with the first threaded sleeve 18.L having a left-handed inner thread, and the right-handed external thread being in engagement with the second threaded sleeve 18.R having a right-handed inner thread.

When the pipe 3.3 is rotated about its longitudinal axis 3.3.A, the threaded sleeves 18.L, 18.R move either towards or away from each other. This movement deforms the deformable sub-frame 4 in such a way that the extent of the deformable sub-frame 4 transverse to the traveling direction F changes.

The rotation of the pipe 3.3 about its longitudinal axis 3.3.A and thus the movement of the threaded sleeves 18.L, 18.R is effected by an adjusting unit (not shown) associated with the pipe 3.3, which is a hydraulic actuator controllable by means of a control unit.

In contrast to the embodiment shown in FIG. 4, in which the pipe 3.3 is arranged on the soil processing unit 2 and therefore also carries out the vertical movements of the soil processing unit 2 caused by unevenness of the ground, in the embodiment according to FIG. 5 the pipe 3.3 is attached to the frame. According to this embodiment, the pipe 3.3, which has the engagement means, does not also carry out the up and down movements of the soil processing unit 2 and is therefore subjected to considerably less stress. The material stress caused by use of the soil cultivator according to the invention on the field, in particular on the threads of the pipe 3.3, is therefore greatly reduced.

Although the pipe 3.1 is designed as part of the soil processing unit 2 and therefore carries out the up and down movements of the soil processing unit 2, the use of the guide sleeves 16.L, 16.R on the pipe 3.1 makes it possible to design the pipe 3.1 in hard-chrome form. Wear of the guide sleeves 16.L, 16.R is therefore not to be expected.

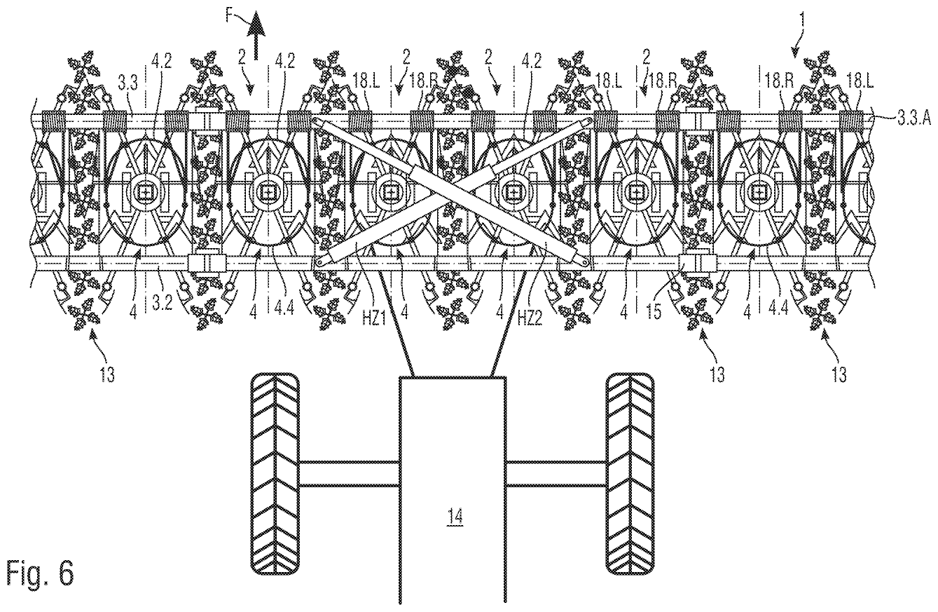

FIG. 6 shows in schematic representation a top view of a soil cultivator according to the invention with tractor 14. In the embodiment shown, the soil cultivator consists of a total of twelve soil processing units 2, of which six soil processing units are shown completely and two further soil processing units are shown partially. Each of these twelve soil processing units 2 is constructed as described in connection with FIG. 4. The pipe 3.3 and the frame pipe 3.2 are each divided into three sections which are interconnected by universal joints 15. Four soil processing units 2 are provided on each of the sections. The frame is indicated only by the frame pipe 3.2. Further elements of the frame are not necessary for the description of the invention and are therefore not shown in FIG. 6.

At each of the two opposite ends of the soil cultivator a modified soil processing unit (not shown) is provided, which only has colters, harrow tines and cultivator sweeps on its side facing the other soil processing units. The other elements are missing. This ensures that the two outermost rows of cultivated plants being worked in the particular operation are cleared of weeds from both sides. The lane following this outer row of crops is worked in two successive passes with the soil cultivator in each case in the area located on one side of the lane centerline.

The two hydraulic cylinders HZ1, HZ2 are connected to each other by frame parts (not shown). These hydraulic cylinders are used to adjust the position of the soil cultivator relative to the tractor when working on a slope.

The two outer sections of the soil cultivator can be folded up to a vertical position by another hydraulic system (not shown), reducing the overall width of the soil cultivator by ⅔. This makes it possible to drive the tractor with soil cultivator on public roads without any problems.

As can be seen from FIG. 6, a number of deformable sub-frames 4 corresponding to the number of soil processing units 2 are provided. Thus, the pipe 3.3 has twelve left-handed external threads and twelve right-handed external threads, each of the left-handed external threads being in engagement with a respective first threaded sleeve 18.L, and each of the right-handed external threads being in engagement with a respective second threaded sleeve 18.R having a right-handed inner thread. A rotation of the pipe 3.3 about its longitudinal axis 3.3.A deforms the deformable sub-frame or deformable sub-frames 4 in such a way that the extent of the twelve deformable sub-frames 4 transversely to the traveling direction F changes in the same way.

Shown are several rows of cultivated plants 13. The tractor 14 moves the soil cultivator in the traveling direction parallel to the rows of cultivated plants. Each lane between two rows of cultivated plants is associated with a soil processing unit 2. When using the soil cultivator, the leading front colters create depressions of several centimeters in the soil. The three cultivator sweeps are pulled through the soil at a shallow depth, cutting through the roots of the weeds growing in the lane between the crops. The two harrow tines scrape up the soil near the crops, simultaneously breaking up the clods and chunks of soil dislodged by the cultivator sweeps and pulling the weeds to the soil surface. Compacted soil near the crops is broken up by the harrow tines in the process. The two trailing colters move soil toward the crops, filling in the initially created depressions and accumulating soil near the crops.

Since, as described above, each of the twelve soil processing units has two harrow tines, three cultivator sweeps and four colters, which are all moved together with the respective subframe, the complete tillage between the rows of cultivated plants can be adapted to the specific local conditions. The distance between the harrow tines, as well as the distance between the colters and the distance between the cultivator sweeps can be adapted to the field to be worked.

With the aid of the hydraulic actuator, which can be controlled by means of a control unit, the rotation of the frame pipe, which has the external threads, can also be carried out from the tractor during tillage. The extent of the deformable sub-frames 4 can thus be easily and quickly adjusted to the prevailing conditions on the field, if required, without having to interrupt the soil cultivation process.

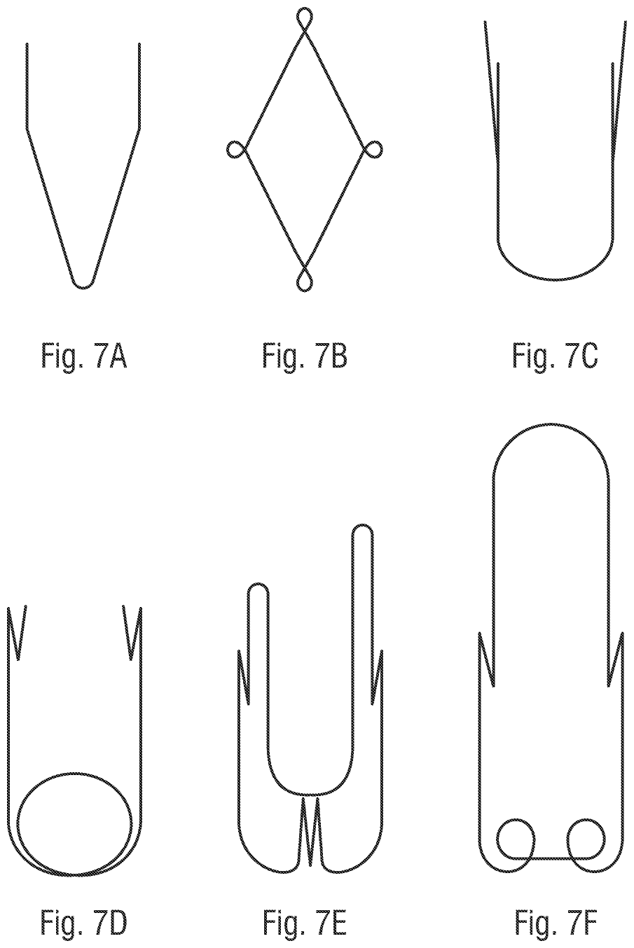

The embodiments of FIGS. 1 to 6 all exhibit a deformable sub-frame 4 constructed from a first 4.1, a second 4.2, a third 4.3 and a fourth sub-element 4.4, wherein the first 4.1 and the third sub-element 4.3 are formed from a linear piece of spring steel, while the second 4.2 and the fourth sub-element 4.4 are formed from a piece of spring steel bent into a U-shape. The individual sub-elements are firmly connected to each other and together form a deformable sub-frame 4 consisting of elastic spring steel. This type of deformable sub-frame 4 has an approximately oval shape with two linear sections. FIGS. 7A, 7B, 7C, 7D, 7E and 7F show further examples of deformable sub-frames 4, with FIGS. 7A, 7C and 7D showing open elements 4, while FIGS. 7B, 7E and 7F show closed embodiments.

FIGS. 7A, 7B, 7C, 7D, 7E and 7F illustrate that there are a great many possible variations with respect to the specific embodiment of the deformable sub-frame 4. What all deformable sub-frames have in common is that they are made of an elastic material and that they can be elastically deformed when force is applied in such a way that the extent of the deformable sub-frame changes transversely to the traveling direction.

### LIST OF REFERENCE SIGNS

2 soil processing unit
3.1 pipe
3.2 frame pipe
3.1. longitudinal axis of the pipe
3.2. longitudinal axis of the frame pipe
4 deformable sub-frame
4.1 first sub-element of the deformable sub-frame
4.2 second sub-element of the deformable sub-frame
4.3 third sub-element of the deformable sub-frame
4.4 fourth sub-element of the deformable sub-frame
4.1.4 first fixing element
4.2.1 second fixing element
4.3.2 third fixing element
4.4.3 fourth fixing element
5.1 first harrow tine
5.2 second harrow tine
5.1.D, 5.2.D wires
7.L.1, 7.L.2 rod parts
7.R.1, 7.R.2 rod parts
8.1 first cultivator sweep
8.2 second cultivator sweep
8.3 third cultivator sweep
8.2.V, 8.3.V connecting member
9.V.L first colter
9.V.R second colter
9.H.R third colter
9.H.L fourth colter
9.V.L.V first auxiliary connecting member
9.V.R.V second auxiliary connecting member
9.H.R.V third auxiliary connecting member
9.H.L.V fourth auxiliary connecting member
10 ring
11 support foot
12 depth guide wheel
13 crop
14 tractor
15 universal joint
16.L first guide sleeve
16.R second guide sleeve
17.L first elongated rod part
17.R second elongated rod part
18.L first actuator
18.R second actuator
19 adjusting unit
20 movement transmission
21 pivot point
22 elongated hole
GML lane centerline
F traveling direction
HZ1, HZ2 hydraulic cylinder

What is claimed and desired to be secured by Letters Patent is:

1. A soil cultivator for mechanical weed control between rows of cultivated plants, comprising:
a frame attachable to a tractor for movement along a traveling direction,
at least one soil processing unit attached to the frame, wherein the at least one soil processing unit comprises a deformable sub-frame made of an elastic material,
a first, movably configured, adjusting means, wherein the first adjusting means is connected to the deformable sub-frame via at least a first connecting element, and a second, movably configured, adjusting means, wherein the second adjusting means is connected to the deformable sub-frame via at least a second connecting element, and
at least one adjusting unit for carrying out a movement of the first and the second adjusting means, the deformable sub-frame being elastically deformable by the movement of the first and the second adjusting means such that an extent of the deformable sub-frame changes transverse to the traveling direction.

2. The soil cultivator according to claim 1, wherein the elastic material comprises: an elastomer, a thermoplastic, a rubber, a hard rubber, steel, or spring steel.

3. The soil cultivator according to claim 1, wherein the deformable sub-frame comprises a one-piece design, or several sub-elements which are immovable relative to one another and fixedly connected to one another.

4. The soil cultivator according to claim 1, wherein the deformable sub-frame has an open or closed design.

5. The soil cultivator according to claim 1, wherein the deformable sub-frame runs in a plane, wherein the deformable sub-frame comprises at least one loop, wherein the loop runs in the plane of the deformable sub-frame or perpendicular to the plane of the deformable sub-frame.

6. The soil cultivator according to claim 1, wherein the first connecting element comprises at least one joint, and the second connecting element comprises at least one joint.

7. The soil cultivator according to claim 1, further comprising a pipe arranged transverse to the traveling direction, wherein the pipe includes at least a first guide sleeve and a second guide sleeve, wherein an exterior side of the first guide sleeve includes a first force transmission means connected thereto, and the exterior side of the second guide sleeve includes a second force transmission means connected thereto, wherein a connection between the first, movably configured adjusting means and the deformable sub-frame includes connecting the first, movably configured adjusting means with the first guide sleeve via the first force transmission means, and connecting the first guide sleeve with the deformable sub-frame via the first connecting element, and wherein a connection between the second, movably configured adjusting means and the deformable sub-frame includes connecting the second, movably configured adjusting means with the second guide sleeve via the second force transmission means, and connecting the second guide sleeve with the deformable sub-frame via the second connecting element, wherein the first and the second force transmission means comprise a first and a second rod part, wherein the first and second rod part have different lengths.

8. The soil cultivator according to claim 7, wherein the first and the second force transmission means each comprise a respective pin-like protrusion on the exterior side of the first guide sleeve and on the exterior side of the second guide sleeve, wherein the exterior sides of the first adjusting means and the second adjusting means each comprise a fork-like pair of protrusions, wherein the pin-like protrusion of the first guide sleeve is engaged with the fork-like pair of protrusions of the first adjusting means, and the pin-like protrusion of the second guide sleeve is engaged with the fork-like pair of protrusions of the second adjusting means.

9. The soil cultivator according to claim 1, wherein the at least one adjusting unit effects a linear movement of the first and the second adjusting means oriented transverse to the traveling direction, wherein the movement of the first adjusting means is oriented antiparallel to the movement of the second adjusting means, and wherein the at least one adjusting unit is an electric or hydraulic actuator actuated by a control device.

10. The soil cultivator according to claim 1, wherein a plurality of soil processing units with a plurality of deformable sub-frames are arranged on the frame.

11. The soil cultivator according to claim 10, wherein movement of the first and the second adjusting means deforms the plurality of deformable sub-frames such that the extent of the deformable sub-frames transverse to the traveling direction changes in the same way.

12. The soil cultivator according to claim 1, wherein each soil processing unit further comprises a first and a second harrow tine, wherein the first and the second harrow tine are connected to the deformable sub-frame of the respective soil processing unit.

13. The soil cultivator according to claim 1, wherein each soil processing unit further comprises a first cultivator sweep, a second cultivator sweep and a third cultivator sweep, wherein the first, second and third cultivator sweeps are offset relative to each other in the traveling direction and transverse to the traveling direction such that the cultivator sweeps form an isosceles triangle, wherein the first cultivator sweep forms a leading or trailing tip of the isosceles triangle in the traveling direction, and wherein the second and the third cultivator sweeps are connected to the deformable sub-frame of the respective soil processing unit.

14. The soil cultivator according to claim 1, further comprising a first colter, a second colter, a third colter and a fourth colter arranged on each soil processing unit, wherein the respective first and second colters form a front colter pair, and the respective third and fourth colters form a rear colter pair, wherein the first colter is connected to the deformable sub-frame by a first auxiliary connecting means, the second colter is connected to the deformable sub-frame by a second auxiliary connecting means, the third colter is connected to the deformable sub-frame by a third auxiliary connecting means, and the fourth colter is connected to the deformable sub-frame by a fourth auxiliary connecting means.

15. The soil cultivator according to claim 1, further comprising at least one movement transmission means for carrying out a movement of the first adjusting means and the second adjusting means, wherein the at least one adjusting unit is connected to the first adjusting means and the second adjusting means via the at least one movement transmission means in order to execute a movement of the first and the second adjusting means.
